(19) United States
(12) Patent Application Publication
(10) Pub. No.: US 2026/0339936 A1
(43) Pub. Date: Oct. 29, 2026

(54) NATURAL LANGUAGE-BASED SEARCH ENGINE FOR INFORMATION RETRIEVAL IN ENERGY INDUSTRY

(71) Applicant: SCHLUMBERGER TECHNOLOGY CORPORATION, Sugar Land, TX (US)

(72) Inventors: Avinash LOKHANDE, Pune (IN); Prashanth Pillai, Pune (IN); Atul Laxman KATOLE, Houston, TX (US); Purnaprajna Raghavendra MANGSULI, Pune (IN)

(21) Appl. No.: 19/110,835

(22) PCT Filed: Sep. 13, 2023
(86) PCT No.: PCT/US2023/032579

§ 371 Date: Mar. 12, 2025

(30) Foreign Application Priority Data
Sep. 14, 2022 (IN) 202221052418

(51) Int. Cl. G06F 16/2452; G06F 16/242; G06F 40/295

(52) U.S. Cl. CPC G06F 16/24522; G06F 16/2425; G06F 16/243; G06F 40/295

(57) ABSTRACT

Systems and methods presented herein a natural language query conversion framework configured to convert natural language queries into database-specific queries to enable users not particularly conversant in database query languages and schema. For example, a method includes receiving, via the natural language query conversion framework, a natural language query; converting, via the natural language query conversion framework, the natural language query into a database query using a language model (LM); and executing, via the natural language query conversion framework, the database query against an oil and gas (O&G) database.

### CROSS-REFERENCE TO RELATED APPLICATION

This application claims priority to and the benefit of India Patent Application No. 202221052418, entitled “Natural Language-Based Search Engine for Information Retrieval in Energy Industry,” filed Sep. 14, 2022, which is hereby incorporated by reference in its entirety for all purposes.

### BACKGROUND

The present disclosure generally relates to systems and methods for converting natural language queries into database-specific queries to enable users not particularly conversant in database query languages and schema.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

A reservoir may be a subsurface formation that may be characterized at least in part by its porosity and fluid permeability. As an example, a reservoir may be part of a basin such as a sedimentary basin. A basin can be a depression (e.g., caused by plate tectonic activity, subsidence, and so forth) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, and so forth).

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a natural language query conversion framework configured to convert natural language queries into database-specific queries to enable users not particularly conversant in database query languages and schema. For example, a method includes receiving, via the natural language query conversion framework, a natural language query; converting, via the natural language query conversion framework, the natural language query into a database query using a language model (LM), and executing, via the natural language query conversion framework, the database query against an oil and gas (O&G) database.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 illustrates an example computing system, in accordance with embodiments of the present disclosure;

FIG. 2 illustrates a survey operation being performed by a survey tool, such as a seismic truck, to measure properties of a subterranean formation, in accordance with embodiments of the present disclosure;

FIG. 3 illustrates a drilling operation being performed by drilling tools suspended by a rig and advanced into a subterranean formation to form a wellbore, in accordance with embodiments of the present disclosure;

FIG. 4 illustrates a wireline operation being performed by a wireline tool suspended by the rig and into the wellbore of FIG. 3, in accordance with embodiments of the present disclosure;

FIG. 5 illustrates a production operation being performed by a production tool deployed from a production unit or Christmas tree and into a completed wellbore for drawing fluid from downhole reservoirs into surface facilities, in accordance with embodiments of the present disclosure;

FIG. 6 illustrates a schematic view, partially in cross section, of an oilfield having data acquisition tools positioned at various locations along the oilfield for collecting data for a subterranean formation, in accordance with embodiments of the present disclosure;

FIG. 7 illustrates an oilfield for performing production operations, in accordance with embodiments of the present disclosure;

FIG. 8 illustrates an embodiment of a flowchart of a natural language query conversion framework for converting natural language queries to database queries, in accordance with embodiments of the present disclosure;

FIG. 9 illustrates a multi-task training framework using a transformer-based language model (LM), addressing multiple O&G domain tasks, in accordance with embodiments of the present disclosure;

FIG. 10 illustrates a database query-to-natural language workflow utilizing the LM, in accordance with embodiments of the present disclosure;

FIG. 11 illustrates examples of Levenshtein distance and metaphone algorithms, which may be used as part of a record matching algorithm, in accordance with embodiments of the present disclosure;

FIG. 12 illustrates a flowchart of an example record matching workflow for spelling correction, which may be implemented by the record matching algorithm, in accordance with embodiments of the present disclosure; and

FIG. 13 is a flow diagram of a method for utilizing a natural language query conversion framework, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another, Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, by a computing system (i.e., solely by the computing system, without human intervention).

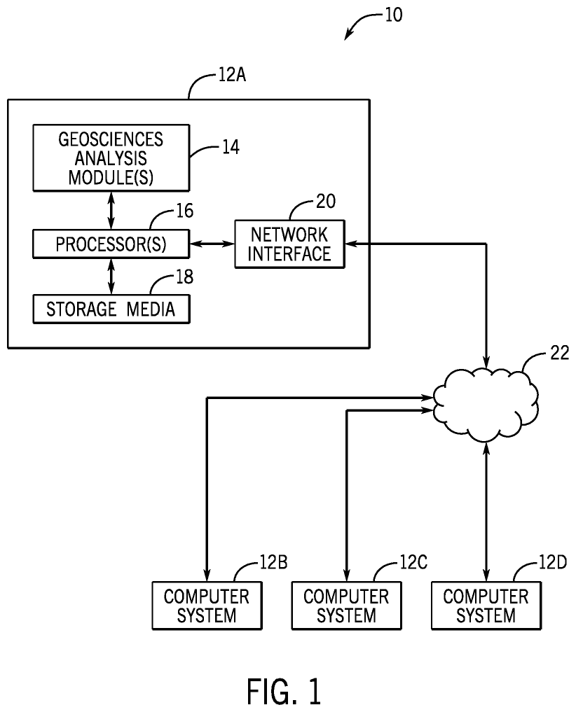

FIG. 1 illustrates an example computing system 10 in accordance with embodiments of the present disclosure. In certain embodiments, the computing system 10 may include an individual computer 12A or an arrangement of distributed computers 12B, 12C, 12D. In certain embodiments, the computer 12A may include one or more geosciences analysis modules 14 that are configured to perform the various tasks described herein. To perform these various tasks, the geosciences analysis modules 14 may execute independently, or in coordination with, one or more processors 16, which may be connected to one or more storage media 18. In certain embodiments, the processor(s) 16 may also be connected to a network interface 20 to enable the computer 12A to communicate over a communication network 22 with one or more additional computers and/or computing systems, such as computers 12B, 12C, and/or 12D. It should be noted that the computers 12B, 12C and/or 12D may or may not share the same architecture as the computer 12A, and may be located in different physical locations. For example, the computers 12A and 12B may be on a ship underway on the ocean, while in communication with one or more computers 12C and/or 12D that are located in one or more data centers on shore, other ships, and/or located in varying countries on different continents. It should also be noted that the communication network 22 may be a private network, it may use portions of public networks, it may include remote storage and/or applications processing capabilities (e.g., cloud computing).

In certain embodiments, the processor(s) 16 may include a microprocessor, microcontroller, processor module or subsystem, programmable integrated circuit, programmable gate array, or another control or computing device. In addition, in certain embodiments, the storage media 18 may be implemented as one or more computer-readable or machine-readable storage media. It should be noted that while in the example embodiment of FIG. 1, the storage media 18 is illustrated as being disposed within the computer 12A, in other embodiments, the storage media 18 may be distributed within and/or across multiple internal and/or external enclosures of the computer 12A and/or additional computers 12B, 12c, 12D. In certain embodiments, the storage media 18 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices.

It should be noted that the instructions discussed herein may be provided on one computer-readable or machine-readable storage medium, or alternatively, may be provided on multiple computer-readable or machine-readable storage media distributed in a large system having possibly plural nodes and/or non-transitory storage means. Such computer-readable or machine-readable storage medium or media may be considered to be part of an article (or article of manufacture). An article or article of manufacture may refer to any manufactured single component or multiple components. In certain embodiments, the storage medium or media may be located either in the machine running the machine-readable instructions, or located at a remote site from which machine-readable instructions may be downloaded over the communication network 22 for execution.

It should be appreciated that the computer 12A is but one example of a computer, and that the computer 12A may have more or fewer components than shown, may combine additional components not depicted in the example embodiment of FIG. 1, and/or the computer 12A may have a different configuration or arrangement of the components depicted in FIG. 1. In addition, in certain embodiments, various components shown in FIG. 1 may be implemented in hardware, software, or a combination of both, hardware and software, including one or more signal processing and/or application specific integrated circuits.

It should also be appreciated that while no user input/output peripherals are illustrated with respect to the computers 12A, 12B, 12C, and 12D, many embodiments of the computing system 10 may include computers with keyboards, mice, touch screens, displays, and so forth. In addition, some computers in use in the computing system 10 may be desktop workstations, laptops, tablet computers, smartphones, server computers, and so forth.

Further, the steps in the processing methods described herein may be implemented by running one or more functional modules in information processing apparatus such as general purpose processors or application specific chips, such as ASICS, FPGAS, PLDs, or other appropriate devices. These modules, combinations of these modules, and/or their combination with general hardware are included within the scope of protection.

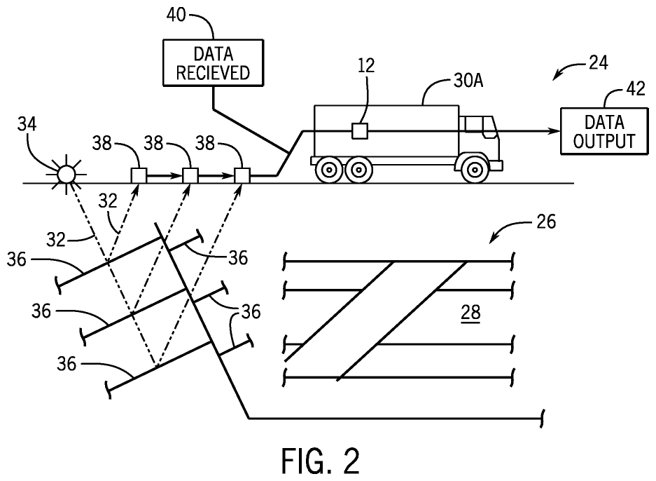

FIGS. 2-5 illustrate simplified, schematic views of an oilfield 24 having a subterranean formation 26 containing a reservoir 28 therein in accordance with implementations of various technologies and techniques described herein. For example, FIG. 2 illustrates a survey operation being performed by a survey tool, such as a seismic truck 30A, to measure properties of the subterranean formation 26. In certain embodiments, the survey operation may be a seismic survey operation for producing sound vibrations. In FIG. 2, one such sound vibration 32, generated by source 34, reflects off horizons 36 in the subterranean formation 26. As illustrated, a set of sound vibrations may be received by sensors 38 (e.g., geophone-receivers) situated at the surface of the oilfield 24. The data 40 received is provided as input data to a computer 12 of a seismic truck 30A, and responsive to the input data, the computer 12 may generate seismic data output 42. The seismic data output 42 may be stored, transmitted or further processed as desired, for example, by data reduction.

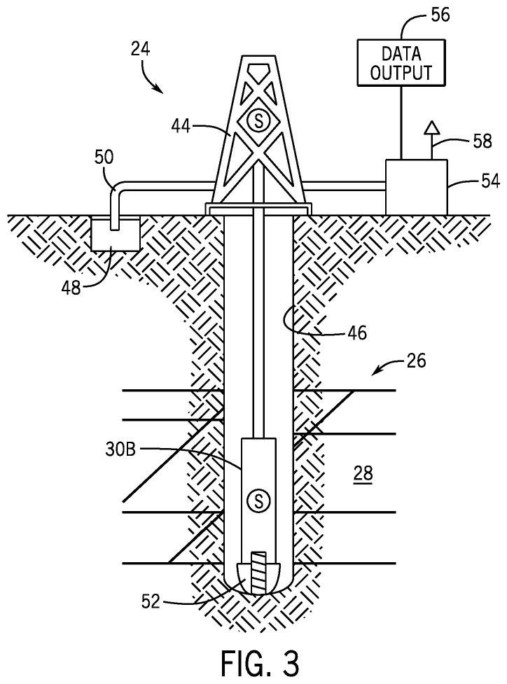

FIG. 3 illustrates a drilling operation being performed by drilling tools 30B suspended by a rig 44 and advanced into the subterranean formation 26 to form a wellbore 46. In certain embodiments, a mud pit 48 may be used to draw drilling mud into the drilling tools 30B via a flow line 50 for circulating drilling mud down through the drilling tools, then up through the wellbore 46 and back to the surface of the oilfield 24. In certain embodiments, the drilling mud may be filtered and returned to the mud pit 48. In certain embodiments, a circulating system may be used for storing, controlling, or filtering the flowing drilling mud. In certain embodiments, the drilling tools 30B may be advanced into the subterranean formation 26 to reach the reservoir 28. In general, each well may target one or more reservoirs 28. The drilling tools 30B may be configured to measure downhole properties, for example, using logging while drilling (LWD) tools. In certain embodiments, the LWD tools may also be configured to capture a core sample 52, as illustrated.

In certain embodiments, computer facilities (e.g., the surface unit 54) may be positioned at various locations about the oilfield 24 and/or at remote locations. The surface unit 54 may be used to communicate with the drilling tools 30B and/or offsite operations, as well as with other surface or downhole sensors. In certain embodiments, the surface unit 54 may be configured to communicate with the drilling tools 30B to send control commands to the drilling tools 30B and to receive data therefrom. In addition, in certain embodiments, the surface unit 54 may also be configured to collect data generated during a drilling operation and produce data output 56, which may then be stored or transmitted.

In certain embodiments, various sensors, such as gauges, may be positioned about the oilfield 24 to collect data relating to various oilfield operations as described herein. For example, in certain embodiments, sensor may be positioned in one or more locations in the drilling tools 30B and/or at the rig 44 to measure drilling parameters, such as weight on bit, torque on bit, pressures, temperatures, flow rates, compositions, rotary speed, and/or other parameters of the field operation. In certain embodiments, sensors may also be positioned in one or more locations in the circulating system.

In certain embodiments, the drilling tools 30B may include a bottom hole assembly (BHA) (not shown) near the drill bit of the drilling tools 30B (e.g., within several drill collar lengths from the drill bit). In such embodiments, the bottom hole assembly may include capabilities for measuring, processing, and storing information, as well as communicating with the surface unit 54. The bottom hole assembly may further include drill collars for performing various other measurement functions. In addition, the bottom hole assembly may include a communication subassembly configured to communicate with the surface unit 54. The communication subassembly may be adapted to send signals to and receive signals from the surface using a dedicated communications channel such as mud pulse telemetry, electromagnetic telemetry, or wired drill pipe communications. The communication subassembly may include, for example, a transmitter that generates a signal, such as an acoustic or electromagnetic signal, which is representative of measured drilling parameters. It should be appreciated that a variety of telemetry systems may be employed, such as wired drill pipe, electromagnetic or other known telemetry systems.

Typically, the wellbore 46 may be drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. In addition, the earth model may also need adjustment as new information is collected.

The data gathered by the sensors may be collected by the surface unit 54 and/or other data collection sources for analysis or other processing. The data collected by the sensors may be used alone or in combination with other data. In addition, the data may be collected in one or more databases and/or transmitted on or offsite. In addition, the data may be historical data, real time data, or combinations thereof. The real time data may be used in real time, or stored for later use. The data may also be combined with historical data or other inputs for further analysis. In certain embodiments, the data may be stored in separate databases, or combined into a single database.

In certain embodiments, the surface unit 54 may include a transceiver 58 configured to enable communications between the surface unit 54 and various portions of the oilfield 24 or other locations. The surface unit 54 may also be provided with or functionally connected to one or more controllers (not shown) for actuating mechanisms at the oilfield 24. The surface unit 54 may then send command signals to the oilfield 24 in response to the received data. In certain embodiments, the surface unit 54 may receive commands via the transceiver 58 or may itself execute commands to the controller. In certain embodiments, a processor may be provided to analyze the data (locally or remotely), make the decisions and/or actuate the controller. In this manner, the oilfield 24 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In certain situations, well plans may be adjusted to select optimum (or improved) operating condition, or to avoid problems.

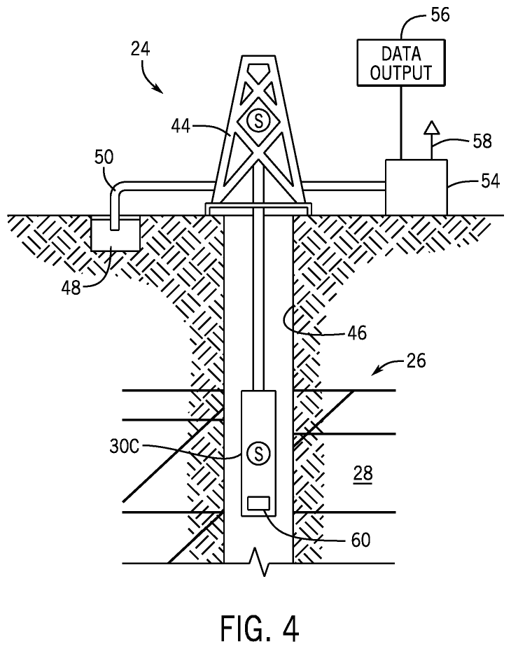

FIG. 4 illustrates a wireline operation being performed by a wireline tool 30C suspended by the rig 44 and into the wellbore 46 of FIG. 3. The wireline tool 30C may be adapted for deployment into the wellbore 46 for generating well logs, performing downhole tests and/or collecting samples. In addition, in certain embodiments, the wireline tool 30C may be used to provide another method and apparatus for performing a seismic survey operation. The wireline tool 30C may, for example, have an explosive, radioactive, electrical, or acoustic energy source 60 that sends and/or receives electrical signals to the surrounding subterranean formation 26 and fluids therein.

In certain embodiments, the wireline tool 30C may be operatively connected to, for example, geophones 38 and a computer 12 of a seismic truck 30A of FIG. 2. The wireline tool 30C may also provide data to the surface unit 54. In addition, the surface unit 54 may collect data generated during the wireline operation and may produce data output 56 that may be stored or transmitted. In addition, the wireline tool 30C may be positioned at various depths in the wellbore 46 to provide a survey or other information relating to the subterranean formation 26.

Sensors, such as gauges, may be positioned about oilfield 24 to collect data relating to various field operations, as described previously. For example, sensors may be positioned in the wireline tool 30C to measure downhole parameters which, for example, relate to porosity, permeability, fluid composition, and/or other parameters of the field operation.

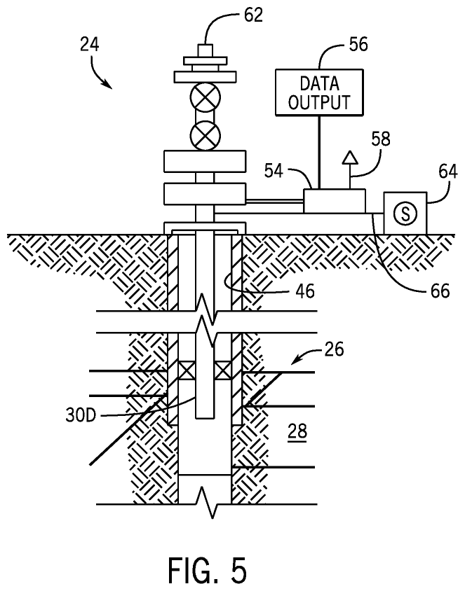

FIG. 5 illustrates a production operation being performed by a production tool 30D deployed from a production unit or Christmas tree 62 and into a completed wellbore 46 for drawing fluid from downhole reservoirs 28 into surface facilities 64. The fluid may flow from a reservoir 28 through perforations in the casing (not shown) and into the production tool 30D in the wellbore 46 and to surface facilities 64 via a gathering network 66.

Sensors, such as gauges, may be positioned about the oilfield 24 to collect data relating to various field operations, as described previously. For example, sensors may be positioned in the production tool 30D or associated equipment, such as the Christmas tree 62, the gathering network 66, the surface facilities 64, and/or a production facility, to measure fluid parameters, such as fluid composition, flow rates, pressures, temperatures, and/or other parameters of the production operation. In certain scenarios, production may also include injection wells for added recovery. In addition, one or more gathering facilities may be operatively connected to one or more of the wellsites for selectively collecting downhole fluids from the wellsite(s).

While FIGS. 2 through 5 illustrate tools 30 used to measure properties of an oilfield 24, it will be appreciated that the tools 30 may be used in connection with non-oilfield operations, such as gas fields, mines, aquifers, storage or other subterranean facilities. In addition, while certain data acquisition tools 30 are depicted, it will be appreciated that various measurement tools capable of sensing parameters, such as seismic two-way travel time, density, resistivity, production rate, and so forth, of the subterranean formation 26 and/or its geological formations may be used. Various sensors may be located at various positions along the wellbore 46 and/or the monitoring tools 30 to collect and/or monitor the desired data. In certain scenarios, other sources of data may also be provided from offsite locations.

The field configurations of FIGS. 2 through 5 are intended to provide a brief description of an example of a field usable with oilfield application frameworks. Part of, or the entirety, of an oilfield 24 may be on land, water, and/or sea. In addition, while a single field measured at a single location is depicted, oilfield applications may be utilized with any combination of one or more oilfields, one or more processing facilities and one or more wellsites.

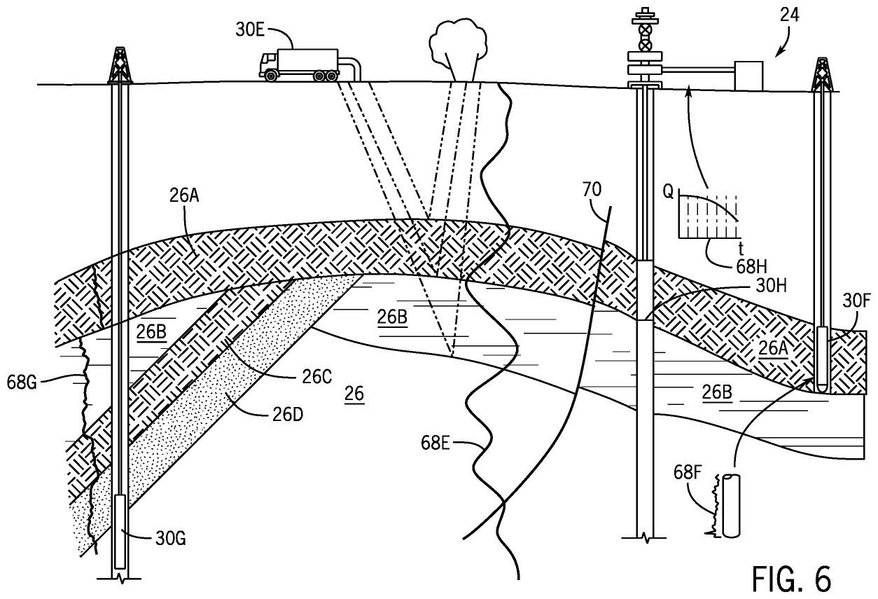

FIG. 6 illustrates a schematic view, partially in cross section, of an oilfield 24 having data acquisition tools 30E, 30F, 30G, 30H positioned at various locations along the oilfield 24 for collecting data for a subterranean formation 26 in accordance with implementations of various technologies and techniques described herein. In certain embodiments, the data acquisition tools 30E, 30F, 30G, 30H may be the same as the data acquisition tools 30A, 30B, 30C, 30D illustrated in, and described with reference to, FIGS. 2-5, respectively, or others not depicted. As illustrated in FIG. 6, the data acquisition tools 30E, 30F, 30G, 30H may each generate data plots or measurements 68E, 68F, 68G, 68H, respectively. These data plots 68E, 68F, 68G, 68H are depicted along the oilfield 24 to demonstrate the data generated by the various operations.

In certain embodiments, the data plots 68E, 68F, 68G are examples of static data plots that may be generated by the data acquisition tools 30E, 30F, 30G, respectively. However, it should be understood that the data plots 68E, 68F, 68G may also be data plots that are updated in substantially real time during deployment and operation of the respective data acquisition tools 30E, 30F, 30G. As described in greater detail herein, these measurements may be analyzed to better define the properties of one or more formation(s) 26A, 26B, 26C, 26D and/or determine the accuracy of the measurements and/or for checking for errors. In addition, in certain embodiments, the plots 68E, 68F, 68G, 68H of some of the respective measurements may be aligned and scaled with each other for comparison and verification of the properties of the one or more formation(s) 26A, 26B, 26C, 26D.

In certain embodiments, the static data plot 68E may be a seismic two-way response over a period of time. In addition, in certain embodiments, the static plot 68F may be a core sample data measured from a core sample of the subterranean formation 26. The core sample may be used to provide data, such as a graph of the density, porosity, permeability, or some other physical property of the core sample over the length of the core. In addition, tests for density and viscosity may be performed on the fluids in the core at varying pressures and temperatures. In addition, in certain embodiments, the static data plot 68G may be a logging trace that typically provides a resistivity or other measurement of the formation at various depths. In addition, in certain embodiments, a production decline curve or graph 68H may be a dynamic data plot of the fluid flow rate over time. The production decline curve 68H typically provides the production rate as a function of time. As the fluid flows through the wellbore 46, measurements may be taken of fluid properties, such as flow rates, pressures, composition, and so forth. In addition, in certain embodiments, other data may also be collected, such as historical data, user inputs, economic information, and/or other measurement data and other parameters of interest. As described in greater detail herein, the static and dynamic measurements may be analyzed and used to generate models of subterranean formation(s) 26 to determine characteristics thereof. Similar measurements may also be used to measure changes in formation aspects over time.

As illustrated in FIG. 6, a subterranean formation 26 may have a plurality of geological formations 26A, 26B, 26C, 26D. In particular, the illustrated subterranean formation 26 has several formations or layers, including a shale layer 26A, a carbonate layer 26B, a shale layer 26C, and a sand layer 26D. As also illustrated, a fault 70 extends through the shale layer 26A and the carbonate layer 26B. The static data acquisition tools are adapted to take measurements and detect characteristics of the geological formations 26A, 26B, 26C, 26D.

While a specific subterranean formation 26 with specific geological structures 26A, 26B, 26C, 26D is depicted in FIG. 6, it will be appreciated that an oilfield 24 may contain a variety of geological structures and/or formations 26, sometimes having extreme complexity. For example, in some locations, typically below the water line, fluid may occupy pore spaces of the formations 26. Each of the data acquisition tools 30 may be used to measure properties of the formations 26 and/or its geological features. While each data acquisition tool 30E, 30F, 30G, 30H is illustrated in FIG. 6 as being in specific locations in the oilfield 24, it will be appreciated that one or more types of measurement may be taken at one or more locations across one or more fields or other locations for comparison and/or analysis.

The data collected from various sources, such as the data acquisition tools 30E, 30F, 30G, 30H of FIG. 6, may then be processed and/or evaluated as described in greater detail herein. Typically, seismic data displayed in the static data plot 68E generated using data acquired by the data acquisition tool 30E is used by a geophysicist to determine characteristics of the subterranean formations 26 and/or its geological features. The core data shown in the static plot 68F and/or the log data in the well log 68G are typically used by a geologist to determine various characteristics of the subterranean formation. The production data from the graph 68H is typically used by a reservoir engineer to determine fluid flow reservoir characteristics. The data analyzed by the geologist, the geophysicist, and the reservoir engineer may be analyzed using various modeling techniques.

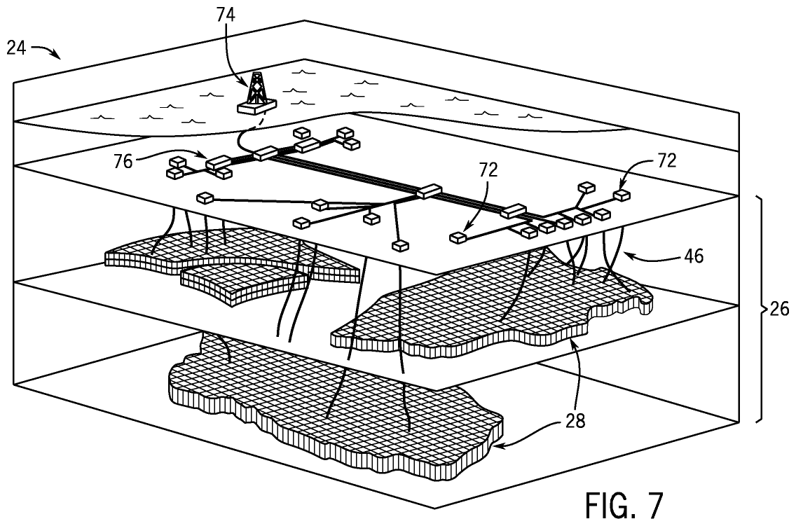

FIG. 7 illustrates an oilfield 24 for performing production operations in accordance with implementations of various technologies and techniques described herein. As illustrated in FIG. 7, the oilfield 24 has a plurality of wellsites 72 operatively connected to A central processing facility 74. The oilfield configuration of FIG. 7 is not intended to limit the scope of the embodiments described herein. Part, or all, of the oilfield 24 may be on land and/or sea. In addition, while a single oilfield 24 with a single processing facility 74 and a plurality of wellsites 72 is illustrated in FIG. 7, any combination of one or more oilfields 24, one or more processing facilities 74, and one or more wellsites 72 may be present.

Each wellsite 72 has equipment that forms one or more wellbores 46 into the earth. The wellbores 46 extend through subterranean formations 26 including reservoirs 28 that contain fluids, such as hydrocarbons. The wellsites 72 draw fluid from the reservoirs 28 and direct the fluids to processing facilities 74 via surface networks 76. In certain embodiments, the surface networks 76 may include tubing and control mechanisms for controlling the flow of fluids from the wellsites 72 to processing facilities 74.

The embodiments described herein include methods, techniques, and workflows for planning, forecasting, and/or optimizing production-related systems (e.g., model selections, reservoir maps, wells, and so forth). Some operations in the processing procedures, methods, techniques, and workflows described herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion. This concept is applicable to the procedures, methods, techniques, and workflows as described herein. This iterative refinement may include use of feedback loops executed on an algorithmic basis, such as at a computing device (e.g., the computing system 10 illustrated in, and described with reference to, FIG. 1), and/or through manual control by a user who may make determinations regarding whether a given step, action, template, or model has become sufficiently accurate.

The oil and gas (O&G) industry generates a significant volume of data from various sources, such as seismic surveys, well logs, drilling, production, and so forth. The data comes in different formats, including structured data (e.g., organized tables) and unstructured data (e.g., text documents, logs, images, and so forth). The data is stored in either relational or non-relational databases, and used to gain valuable insights of various aspects of the O&G lifecycle, including production decision making, operational efficiency, regulatory compliance, and so forth. However, retrieving relevant information from the databases requires end-users to be relatively conversant with database query syntaxes and schema definitions, which is relatively challenging. The embodiments described herein introduce a novel framework to interact with O&G databases using natural language-based searches.

The embodiments described herein may be summarized as follows:
Natural language interface over oil and gas (O&G) databases: A transformer-based language model (LM) has been developed to convert natural language queries (e.g., in English, Spanish, French, and so forth) to the database query syntax (e.g., Structured Query Language (SQL), and so forth). The LM may be trained on curated oil and gas (O&G) datasets.
Multi-lingual interaction with O&G databases: The framework described herein supports multi-lingual O&G databases with muti-lingual natural language queries. For example, an end user may query a Spanish database with English queries and vice versa.
Multi-task training on O&G domain related tasks: Multi-task training has been adopted to create and train a robust LM capable of effectively handling O&G domain specific tasks. Through multi-task training, the LM shares parameters across multiple tasks, enabling it to capture common patterns and features. This approach enhances the LM's understanding of the domain better, as compared to training on individual tasks in isolation.
Database agnostic searches: The framework described herein may be adapted to different types of O&G databases without retraining the LM. This illustrates the zero-shot learning capabilities of the LM.
Workflow for data generation: To train the LM on O&G domain related tasks, the required training data may be prepared using a data generation pipeline. This data generation pipeline may be implemented in two ways: training the LM (1) with database queries to text generation tasks and/or (2) with predefined sentence structure with paraphrasing.
Domain specific record matching for correct data retrieval: The framework described herein may efficiently correct spelling mistakes or typographical errors in the natural language queries to retrieve correct data.

### Multi-Lingual Natural Language Interface Over O&G Databases

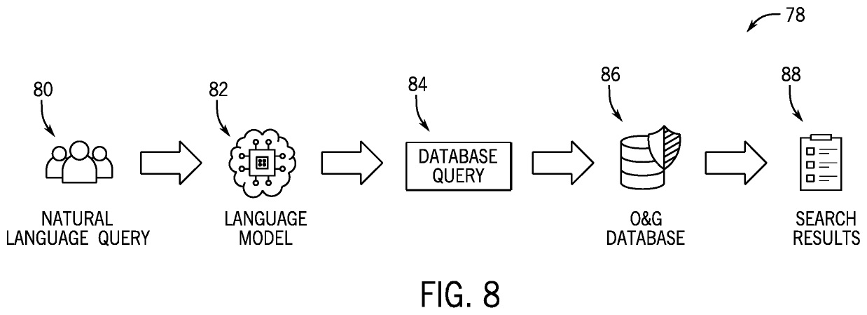

FIG. 8 illustrates an embodiment of a flowchart of a natural language query conversion framework 78 for converting natural language queries to database queries, as described in greater detail herein. As illustrated, the natural language query conversion framework 78 includes receives a natural language query 80 as an input, and uses a language model (LM) 82 to convert the natural language query 80 into a database query 84, which may be used to query an O&G database 86 to produce query results 88, as described in greater detail herein. It will be appreciated that the O&G database 86 may include data including data collected by the various data acquisition tools 30 described with reference to FIGS. 2-6 above. It will also be appreciated that the natural language query conversion framework 78 may be implemented by the computing system 10 described with reference to FIG. 1 above.

The embodiments described herein solve the challenges of writing complex database queries to retrieve information from O&G databases. In particular, the embodiments described herein enable end users to interact with O&G databases using natural language, whether the natural language is in the same language used by a particular O&G database or the natural language is in a natural language (e.g., English, Spanish, French, and so forth) different from that used by the particular O&G database. A transformer-based LM 82, which converts natural language queries to database query syntaxes has been developed. A curated O&G dataset has been created to train the LM 82 on O&G domain queries. In certain embodiments, the LM 82 may be or include a text-to-text transfer transformer (T5) model, which may take input as a natural language query 80 appended with attributes of the database schema and then translate the natural language query 80 appended with attributes of the database schema into a database query 84, which may be used to query an O&G database 86 to generate query results 88.

### Curated Oil and Gas (O&G) Datasets

The curated O&G datasets consist of pairs of natural language queries and corresponding database queries for different O&G entities including wellbore, field, basin, logs, markers, seismic, trajectory and more. Approximately 10% of the samples were generated by domain experts, 20% were derived from historic query records, and 70% of the data was generated by a data generation pipeline. In certain embodiments, to train the LM 82, a few sample queries from domain experts pertaining to energy (e.g., wellbore, field, basin, logs, markers, seismic, trajectory, and so forth) may be obtained. In certain embodiments, the training datasets may be prepared by augmenting domain expert queries with synthetically generated queries. In certain embodiments, a synthetic data generation pipeline may be implemented using database schema information, example values, and historical logs of domain experts.

### Multi-task Training on O&G Domain Related Tasks

As described in greater detail herein, multi-task training was adopted to create a robust LM 82 capable of effectively handling O&G domain-specific tasks. Through multi-task training, the LM 82 shares parameters across tasks, enabling it to capture common patterns and features. This approach enhances the LM's understanding of the particular domains better compared to training on individual tasks in isolation. By employing multi-task training, the LM 82 exhibits an impressive ability to perform well on new tasks even with limited examples. Additionally, the LM 82 can generate outputs for tasks it was not specifically trained on when provided with a natural language prompt.

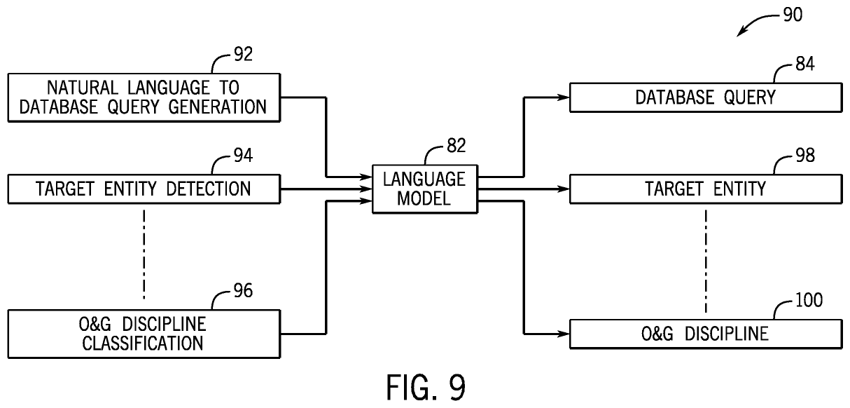

FIG. 9 illustrates a multi-task training framework 90 using a transformer-based LM 82, addressing multiple O&G domain tasks. As illustrated in FIG. 9, multiple tasks 92, 94, 96 may be used to create and refine the LM 82 including, but not limited to, natural language to database query generation 92, target entity detection 94, and O&G discipline classification 96. The LM 82 may then be used to generate database queries 84 for particular target entities 98 in particular O&G disciplines 100, as described in greater detail herein. As described in greater detail herein, the tasks 92, 94, 96 used to create and refine the LM 82 may include enabling conversion of the natural language queries 80 and database queries 84 that are based in different natural languages, thereby enabling multi-lingual searching of O&G databases 86.

### Natural Language to Database Query Generation 92

In this task, the LM 82 translates a natural language query 80 into its corresponding database query 84. In certain embodiments, an instruction prompt such as “Convert to database query” may be appended to the natural language query 80. In addition, in certain embodiments, the entity/schema attributes may be appended to the natural language query 80 to define the scope of output attributes for query generation. An example of an input is as follows:
Convert to database query: Show onshore wells having true vertical depth greater than 3000 m|Vertical Measurement Type|Vertical Measurement Path|Vertical Measurement|Vertical Measurement Unit|CRS|Operator|Name|Facility Event|Facility State|Facility Type|Trajectory|Operating Environment|Geopolitical Entity|Geo Type|Field|Well Id|Alias Name|Alias Name Type|Definition Organization|Kick Off Wellbore|Material|Formation|Drilling Reason|Effective Date|Create Time|Modify Time

As will be appreciated, “Convert to database query” is the instruction prompt, “Show onshore wells having true vertical depth greater than 3000 m” is the natural language query 80, and the remainder is the entity/schema attributes.

### Target Entity Detection 94

The objective of this task is to accurately identify the target entity for a given natural language query 80. To accomplish this, the LM 82 may be trained using a “Detect target entity” instruction prompt as a prefix to the natural language query 80. In addition, the natural language query 80 may be appended with all possible entity classes to enable the LM 82 to learn the entity selection from a given set of entities. This approach provides scalability to the detection task, allowing for the inclusion of new O&G database entities without the need for fine-tuning the LM 82. An example of an input is as follows:
Detect target entity: Show me the profile of wells located in ABC Basin and spud after 2010 |field |basin |well |wellbore |well log |wellbore trajectory |wellbore marker set As will be appreciated, “Detect target entity” is the instruction prompt, “Show me the profile of wells located in ABC Basin and spud after 2010” is the natural language query 80, and the remainder is the entity classes.

### O&G Discipline Classification 96

The objective of this task is to classify definitions, explanations, and illustrations that are commonly used in the O&G industry to their specific disciplines. The disciplines may include drilling, production, geology, geophysics, reservoir characterization, and so forth. While training, the different O&G disciplines may be appended in random number and order to the input definitions, which serves as a context for the LM 82. This task helps the LM 82 to familiarize better with domain terminology and associate with related concepts. An example of an input is as follows:
Classify passage context: Anticline is an arch-shaped fold in rock in which rock layers are upwardly convex. The oldest rock layers form the core of the fold, and outward from the core progressively younger rocks occur. Anticlines form many excellent hydrocarbon traps, particularly in folds with reservoir-quality rocks in their core and impermeable seals in the outer layers of the fold.|Geology |Geophysics|Drilling|Production|Enhanced oil recovery

### Workflow for Data Generation—Database Query to Text Generation Task

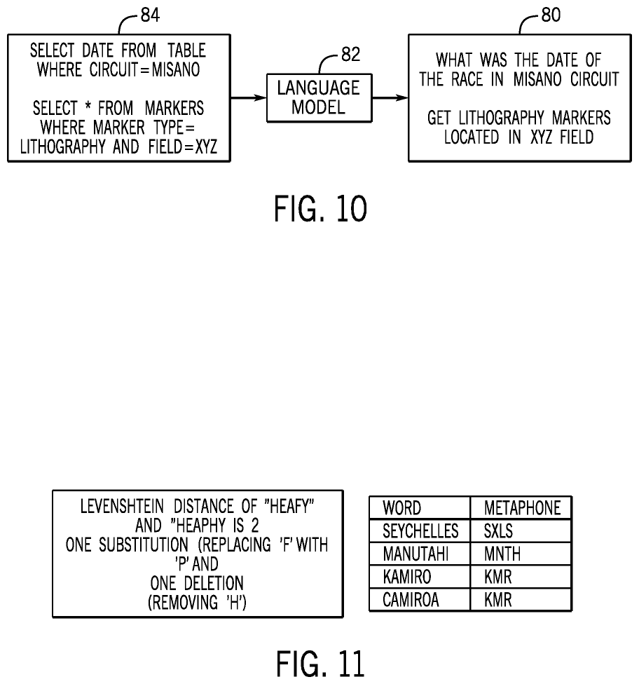

Availability of sufficient natural language and database query pairs greatly affects the predictive performance of the natural language to database query generation model described herein. However, obtaining sufficient training examples for different entity/table schemas is relatively challenging due to the manual efforts that are generally required. However, this challenge has been alleviated by adopting machine-assisted data synthesis utilizing the same transformer-based LM 82 described herein. In this formulation, the LM 82 takes various database queries 84 as inputs and automatically (e.g., without human intervention) predicts corresponding natural language queries 80 as illustrated in FIG. 10. This process provides additional natural language and database query pairs for data augmentation with diverse natural language representation, without the need for domain experts to manually analyze the database queries 84, thereby improving the functionality of the natural language query conversion framework 78 described herein.

### Domain Specific Record Matching for Correct Data Retrieval

While typing a natural language query, a user may make typographical or spelling errors. To rectify these mistakes, a record matching algorithm may be implemented, which may invoke whenever there are no records found using a translated database query 84. In general, the record matching algorithm compares a predicted value with all values corresponding to the predicted attribute in an O&G database 86. If the similar value found (e.g., based on Levenshtein distance or metaphone algorithm), then the predicted value may be replaced with a corrected value. FIG. 11 illustrates examples of Levenshtein distance and metaphone algorithms, which may be used as part of a record matching algorithm.

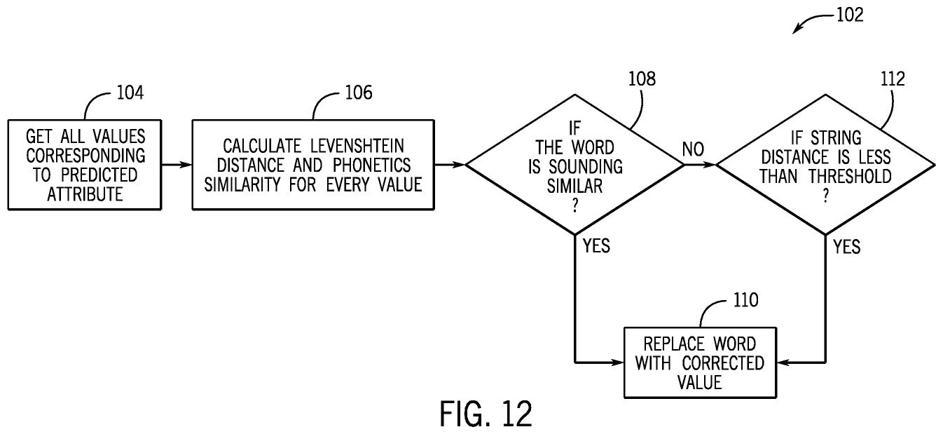

FIG. 12 illustrates a flowchart of an example record matching workflow 102 for spelling correction, which may be implemented by the record matching algorithm. As illustrated in FIG. 12, in certain embodiments, the workflow 102 may include receiving all values corresponding to a predicted attribute (e.g., block 104). Then, a similarity to the predicted value may be calculated for every value (e.g., by determining a Levenshtein distance or phonetics similarity) (e.g., block 106). Then, a determination may be made as to whether the word sounds similar to the corrected value (decision block 108). If the word does sound similar to the corrected value, then the word may be replaced with the corrected value (block 110). However, if the word does not sound similar to the corrected value, then a determination may be made as to whether a difference in similarity (e.g., a Levenshtein distance or phonetics similarity distance) between the word and the corrected value is within a predetermined threshold for level of similarity (e.g., within a predetermined Levenshtein distance threshold or phonetics similarity distance threshold) (decision block 112). If the word is within the predetermined threshold, then the word may be replaced with the corrected value (block 110).

In certain embodiments, the developed natural language query conversion framework 78 described herein may be deployed in an artificial intelligence or machine learning (AI/ML) platform having an application programming interface (API) that facilitates data experts and domain experts to input data that is used by the natural language query conversion framework 78 to enable the natural language query conversion framework 78 to receive natural language queries 80 and to convert the natural language queries 80 into database queries 84, as described in greater detail herein. In certain embodiments, natural language queries 80 may be input by a user via a data workspace application and processed locally by a data workspace application to generate database queries 84 and associated queries results 88, as described in greater detail herein, which may be transmitted back to the data workspace application for display for the user. As such, the natural language query conversion framework 78 described herein enables users to input natural language queries 80 to search domain-specific records in one or more O&G databases 86 (e.g., which may be company-specific, industry-specific such as the open subsurface data universe (OSDU), and so forth). It will be appreciated that the natural language query conversion framework 78 described herein may be implemented via a computing system 10 similar to the one illustrated in, and described with reference to, FIG. 1.

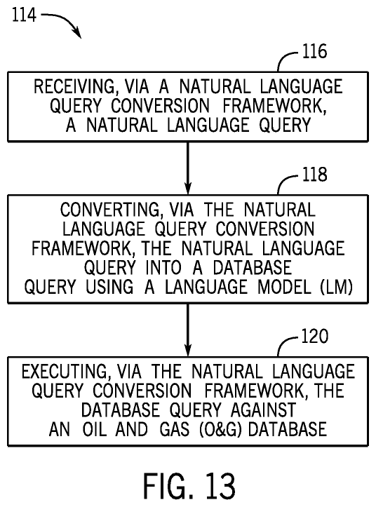

FIG. 13 is a flow diagram of a method 114 for utilizing the natural language query conversion framework 78, as described in greater detail herein. As illustrated in FIG. 13, in certain embodiments, the method 114 may include receiving, via the natural language query conversion framework 78, a natural language query 80 (block 116). In addition, in certain embodiments, the method 114 may include converting, via the natural language query conversion framework 78, the natural language query 80 into a database query 84 using a language model (LM) 82 (block 118). In addition, in certain embodiments, the method 114 may include executing, via the natural language query conversion framework 78, the database query 84 against an oil and gas (O&G) database 86 (block 120).

In certain embodiments, the method 114 may include appending, via the natural language query conversion framework, 78 the natural language query 80 with one or more database schema attributes prior to converting, via the natural language query conversion framework 78, the natural language query 80 into the database query 84 using the LM 82. In addition, in certain embodiments, the method 114 may include, upon determining that no records were found upon execution of the database query 84, comparing, via the natural language query conversion framework 78, a predicted value with all values corresponding to a predicted attribute in the O&G database 86; and replacing, via the natural language query conversion framework 78, the predicted value with a corrected value based on a similar value found in the O&G database 86.

In certain embodiments, converting, via the natural language query conversion framework 78, the natural language query 80 into the database query 84 using the LM 82 includes using target entity detection 94 of the natural language query 80. In addition, in certain embodiments, converting, via the natural language query conversion framework 78, the natural language query 80 into the database query 84 using the LM 82 includes using O&G discipline classification 96 of the natural language query 80. In addition, in certain embodiments, values of the database query 84 are in a natural language different than the natural language query 80.

As described in greater detail herein, a large amount of information in the energy (e.g., oil and gas) industry is stored within databases. Currently, users generally need to be relatively conversant with database query syntaxes and schema definitions to access this information, which can be somewhat challenging. Hence, there is a need to develop a framework to describe database searches in the natural language. With the natural language query conversion framework 78 described herein, a user may access the database information using a natural language search option. As such, the user need not be conversant in database query syntaxes and schema definitions. Therefore, the natural language query conversion framework 78 described herein does not require users to know complex database query language. In addition for a new database schema, retraining of the LM 82 described herein is not required. In existing technology, where users may need to know database query languages to search oil and gas databases, the disclosed natural language query conversion framework 78 may act as a friendly frontend to enable natural language search options. The users may be more productive with such simplified searches. In addition, in certain embodiments, third parties (e.g., competitors and clients) may integrate the developed natural language query conversion framework 78 into their data management systems enabling such external data management systems to leverage the natural language search functionality described herein.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method comprising:
receiving, via a natural language query conversion framework, a natural language query;
converting, via the natural language query conversion framework, the natural language query into a database query using a language model (LM), and
executing, via the natural language query conversion framework, the database query against an oil and gas (O&G) database.

2. The method of claim 1, comprising:
appending, via the natural language query conversion framework, the natural language query with one or more database schema attributes prior to converting, via the natural language query conversion framework, the natural language query into the database query using the LM.

3. The method of claim 1, comprising:
upon determining that no records were found upon execution of the database query, comparing, via the natural language query conversion framework, a predicted value with all values corresponding to a predicted attribute in the O&G database; and
replacing, via the natural language query conversion framework, the predicted value with a corrected value based on a similar value found in the O&G database.

4. The method of claim 1, wherein converting, via the natural language query conversion framework, the natural language query into the database query using the LM comprises using target entity detection of the natural language query.

5. The method of claim 1, wherein converting, via the natural language query conversion framework, the natural language query into the database query using the LM comprises using O&G discipline classification of the natural language query.

6. The method of claim 1, wherein the LM is a transformer-based LM.

7. The method of claim 1, wherein values of the database query are in a natural language different than the natural language query.

8. A computing system, comprising:
one or more processors configured to execute computer-readable instructions stored on memory media of the computing, wherein the computer-readable instructions, when executed by the one or more processors, cause the computing system to:
receive a natural language query;
convert the natural language query into a database query using a language model (LM); and
execute the database query against an oil and gas (O&G) database.

9. The computing system of claim 8, wherein the computer-readable instructions, when executed by the one or more processors, cause the computing system to:
append the natural language query with one or more database schema attributes prior to converting the natural language query into the database query using the LM.

10. The computing system of claim 8, wherein the computer-readable instructions, when executed by the one or more processors, cause the computing system to:
upon determining that no records were found upon execution of the database query, compare a predicted value with all values corresponding to a predicted attribute in the O&G database; and
replace the predicted value with a corrected value based on a similar value found in the O&G database.

11. The computing system of claim 8, wherein converting the natural language query into the database query using the LM comprises using target entity detection of the natural language query.

12. The computing system of claim 8, wherein converting the natural language query into the database query using the LM comprises using O&G discipline classification of the natural language query.

13. The computing system of claim 8, wherein the LM is a transformer-based LM.

14. The computing system of claim 8, wherein values of the database query are in a natural language different than the natural language query.

15. A natural language query conversion framework configured to:
receive a natural language query;
convert the natural language query into a database query using a transformer-based language model (LM); and
execute the database query against an oil and gas (O&G) database.

16. The natural language query conversion framework of claim 15, wherein the natural language query conversion framework is configured to:
append the natural language query with one or more database schema attributes prior to converting, via the natural language query conversion framework, the natural language query into the database query using the transformer-based LM.

17. The natural language query conversion framework of claim 15, wherein the natural language query conversion framework is configured to:
upon determining that no records were found upon execution of the database query, compare a predicted value with all values corresponding to a predicted attribute in the O&G database; and
replace the predicted value with a corrected value based on a similar value found in the O&G database.

18. The natural language query conversion framework of claim 15, wherein converting the natural language query into the database query using the transformer-based LM comprises using target entity detection of the natural language query.

19. The natural language query conversion framework of claim 15, wherein converting the natural language query into the database query using the transformer-based LM comprises using O&G discipline classification of the natural language query.

20. The natural language query conversion framework of claim 15, wherein values of the database query are in a natural language different than the natural language query.
